(19) United States
(12) Patent Application Publication
(10) Pub. No.: US 2011/0198234 A1
(43) Pub. Date: Aug. 18, 2011

(54) METHOD AND APPARATUS FOR SEPARATING SEAWATER INTO CAUSTIC SODA AND FRESH WATER BY USING GREEN ENERGY

(76) Inventor: Oh Sung Bae, Gyeonggi-Do (KR)

(21) Appl. No.: 12/998,391

(22) PCT Filed: Dec. 18, 2009
(86) PCT No.: PCT/KR2009/007581

§ 371 Date: Apr. 14, 2011

(30) Foreign Application Priority Data
Aug. 7, 2009 (KR) PCT/KR2009/004417

(51) Int. Cl. C02F 1/461; C25B 9/00; C02F 1/14; C02F 103/08

(52) U.S. Cl. 205/742; 204/274

(57) ABSTRACT

A method and apparatus are developed for separating the seawater into the caustic soda and fresh water by using green energy. The apparatus includes a water reservoir, a watercourse connected to one side of the water reservoir to flow the seawater through, positive and negative electrodes provided at the opposite sides of water reservoir and watercourse to electrolyze. At one side of the watercourse, the power is supplied to the electrodes, a solar light and a running water power generation are arranged for generating and supplying the electric power to the power supply. An evaporation tower evaporates the soda-containing water to separate caustic soda and fresh water from the water by electricity of vapor turbine generator. Thus, the present apparatus is capable to reduce the product cost of the fresh water and caustic soda, while it is preventing emission of the carbon dioxide from burning the fossil fuels without supplying the external power.

### BACKGROUND OF THE INVENTION

1. Field of the Invention

The present invention relates to a method and an apparatus for separating seawater to caustic soda and fresh water by using green energy. More particularly, the method and apparatus for separating seawater is able to generate electric power from a power generation arrangement and separate into the caustic soda containing 3.5% NaCl and fresh water by using the generated power. So, it is possible to reduce the production cost of the fresh water and the caustic soda without supplying the external power. Therefore, the emission of the carbon dioxide from burning fossil fuels that causes the global warming can be prevented.

2. Related Prior Art

The caustic soda, known as sodium hydroxide, is a representative strong alkali that has the chemical formula NaOH, a molecular weight of 39.997 g/mol, and is a white solid in pure form. Since the caustic soda is hygroscopic and readily absorbs water from the air, it must be stored in an airtight container.

Further, the caustic soda exhibits the strong basic properties in an aqueous solution. With the properties, the caustic soda is widely used as a raw material for manufacturing the pulp, textile, dye, rubber, soap, and the like. Further, the caustic soda is also used as a drying agent due to its strong hygroscopic enabling rapid absorption of water from the air.

Method for producing the caustic soda including Le-Blanc process, which produces the caustic soda by adding the sulfuric acid to a raw salt, then, heating and decomposition. Other method of Ammonia Soda Process is able to produce the caustic soda through reaction of soda ash with Ca(OH)2. An Electrolysis Process produces the caustic soda through electrolysis of salt water. Currently, the electrolysis process, such as a diaphragm process, the mercury process, and the ion exchange membrane process is most broadly used in the art.

In the diaphragm process, an asbestos diaphragm is used to prevent the reaction between caustic soda generated from a steel cathode and chlorine generated from a graphite anode when producing caustic soda.

The mercury process uses mercury as a cathode material to produce caustic soda and is not used anymore due to environmental pollution caused by the use of mercury.

In the ion exchange membrane process, salt water is used as an electrolyte and an ion exchange membrane is disposed in an electrolytic bath to divide the electrolytic bath into two parts, that is, an anode bath and a cathode bath, to which an anode terminal and a cathode terminal are provided, respectively. Then, when power is supplied to the two terminals, chlorine gas is obtained from the anode and hydrogen gas and caustic soda are obtained from the cathode.

Namely, with the ion exchange membrane acting as an osmosis membrane interposed between the anode terminal and the cathode terminal connected to each other, a predetermined amount of water is supplied to the cathode bath where the cathode terminal is disposed, and a predetermined amount of sodium chloride is supplied to the anode bath where the anode terminal is disposed.

In this state, when power is applied to the anode terminal and the cathode terminal, cationic hydrogen ions (H+) are collected on the cathode and anionic chlorine ions (Cl—) are collected on the anode, thereby producing hydrogen gas and chlorine gas, respectively.

As a result, hydroxyl ions (OH—) and sodium ions (Na+) remain and react with each other to produce sodium hydroxide (NaOH).

However, an apparatus for producing caustic soda based on the ion exchange membrane process requires substantial energy consumption for the electrolysis. Such energy is typically obtained from fossil fuels that cause emission of carbon dioxide and thus accelerate global warming.

Moreover, the use of the fossil fuel-based energy causes an increase in production costs of caustic soda.

### SUMMARY OF THE INVENTION

The present invention is conceived to solve the problems of the related art, and an aspect of the invention is to provide a method and apparatus for separating caustic soda and fresh water from seawater by using green energy, that can generate electric power from a power generation arrangement, such as a solar power generation arrangement or a running water power generation arrangement, and separate caustic soda and fresh water from seawater using the generated power, thereby enabling a reduction in costs for production of fresh water and caustic soda from seawater while preventing emission of carbon dioxide and the use of fossil fuels causing global warming without the use of an external power supply.

In accordance with an aspect of the invention, an apparatus for separating caustic soda and fresh water from seawater by using green energy includes: a water reservoir pumping, purifying and electrolyzing a predetermined amount of seawater; a watercourse connected to one side of the water reservoir to allow the seawater electrolyzed from the water reservoir to flow there-through; positive and negative electrodes respectively provided to opposite sides of the water reservoir and the watercourse to electrolyze the seawater; a power supply disposed at one side of the watercourse to supply electricity to the electrodes; a power generation arrangement generating and supplying electric power to the power supplier; and an evaporation tower guiding the caustic soda-containing water, that is, the seawater, electrolyzed through the watercourse into the evaporation tower and evaporating the water to separate caustic soda and fresh water from the caustic soda-containing water by spraying and heating the caustic soda-containing water.

In accordance with an aspect of the invention, a method of separating caustic soda and fresh water from seawater by using green energy includes: generating and supplying, by a solar power generator, electric power to a power supply to supply electricity to electrodes; temporarily storing seawater, from which foreign matter has been removed, in a water reservoir, followed by primarily electrolyzing the seawater through the electrodes; secondarily electrolyzing the primarily electrolyzed seawater through the electrodes in a watercourse while passing the primarily electrolyzed seawater from the water reservoir through the watercourse; generating vapor by raising and ejecting the electrolyzed caustic soda-containing water into an evaporation tower through an ejection port while heating the electrolyzed caustic soda-containing water through an evaporation chamber; receiving the heated vapor from the evaporation chamber through a flow duct to operate a vapor turbine generator for power generation; and collecting caustic soda concentrated in the evaporation chamber through a discharge port while liquefying the remaining vapor after operating the vapor turbine generator.

As such, according to the embodiments, the method and apparatus for separating caustic soda and fresh water from seawater by using green energy can generate electric power from a power generation arrangement, such as a solar power generation arrangement or a running water power generation arrangement, and separate seawater containing 3.5% NaCl into caustic soda and fresh water using the generated power without the use of an external electric power supply, thereby enabling a reduction in costs for production of fresh water and caustic soda from seawater while preventing emission of carbon dioxide and the use of fossil fuels causing environmental pollution and global warming.

Further, in the method and apparatus for separating caustic soda and fresh water from seawater by using green energy, electrolyzed caustic soda-containing water is heated in the evaporation tower to evaporate moisture and evaporated vapor is delivered to the turbine generator, which in turn uses the vapor for power generation and discharges cooled water to be used as fresh water.

### BRIEF DESCRIPTION OF THE DRAWINGS

FIG. 1 is a view of an apparatus for separating caustic soda and fresh water from seawater by using green energy in accordance with one embodiment of the present invention.

FIGS. 2 to 4 are views of a running water power generation arrangement of the apparatus in accordance with the embodiment of the present invention.

FIG. 5 is a view of an evaporation tower of the apparatus in accordance with the embodiment of the present invention.

FIG. 6 is a flowchart of a method of separating caustic soda and fresh water from seawater by using green energy in accordance with one embodiment of the present invention.

FIG. 7 is a flowchart of a subroutine of operation S240 in the method of FIG. 6.

### DETAILED DESCRIPTION OF THE PREFERRED EMBODIMENTS

Embodiments of the invention will now be described in detail with reference to the accompanying drawings.

It should be noted that like components will be denoted by like reference numerals throughout the drawings. Herein, a description of well-known functions or components will be omitted for clarity.

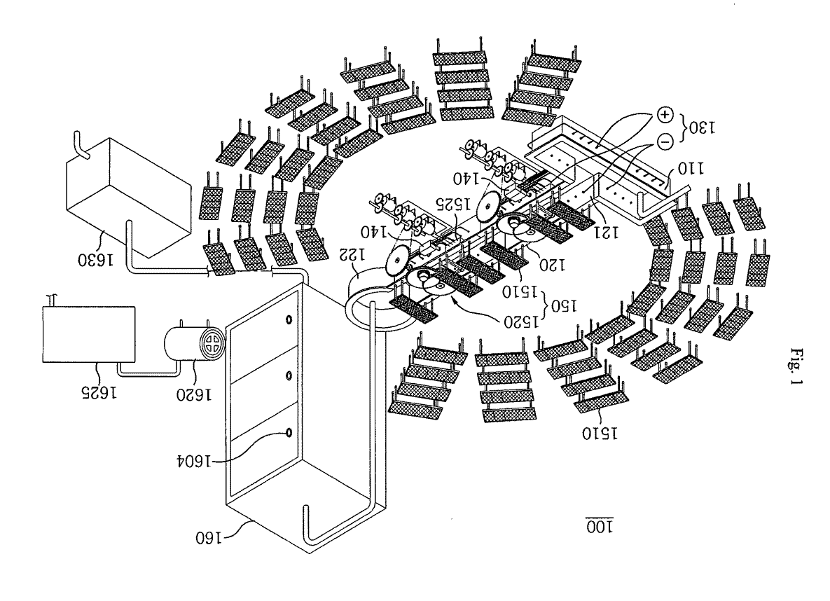

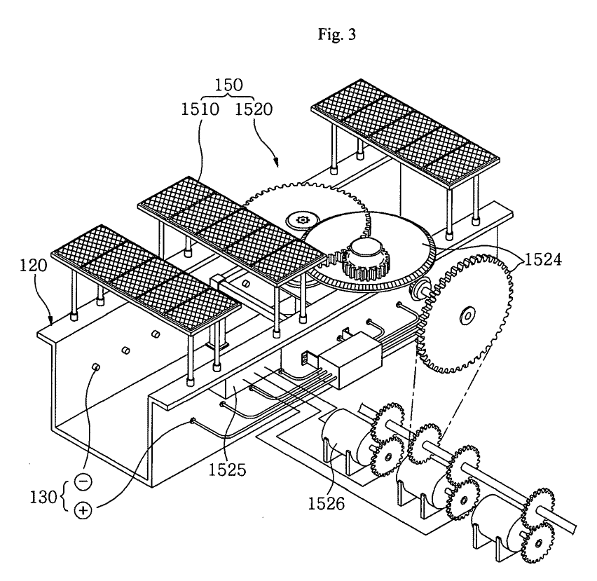

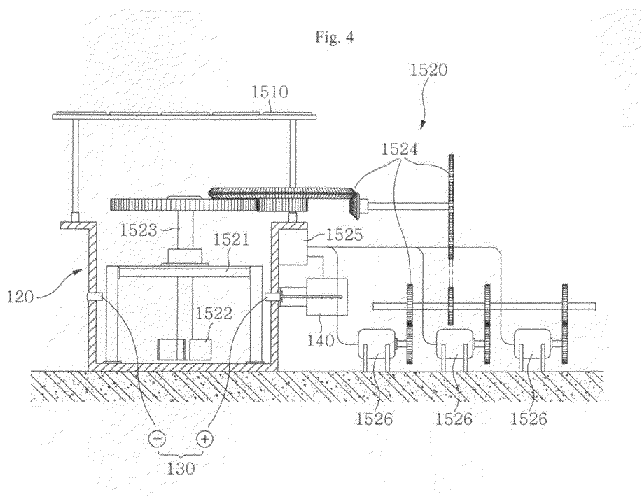

First, an apparatus for separating caustic soda and fresh water from seawater by using green energy in accordance with one embodiment of the invention will be described with reference to FIGS. 1 to 5.

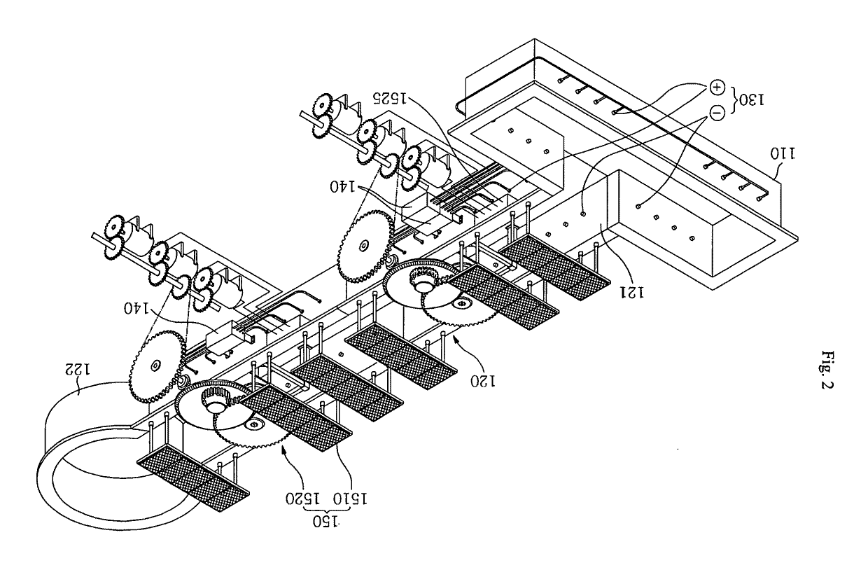

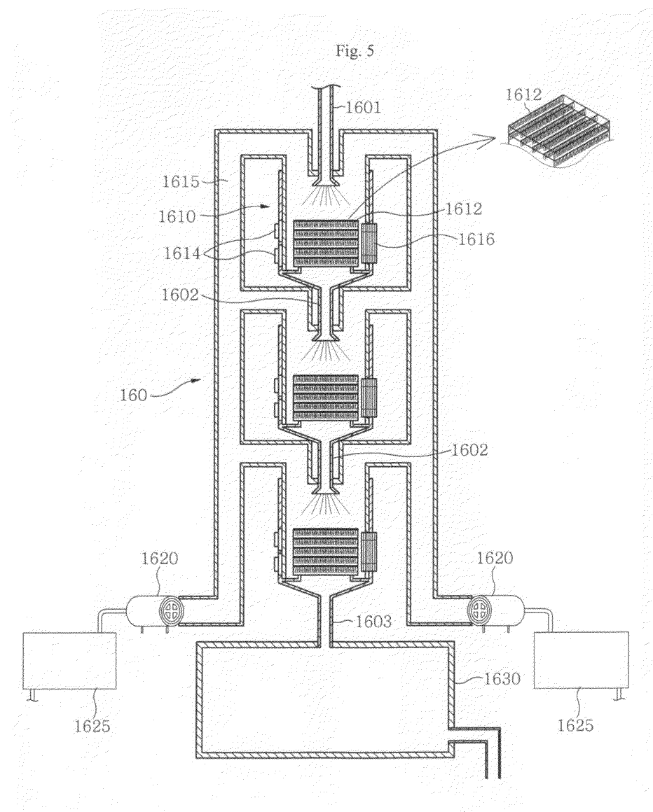

FIG. 1 is a view of an apparatus for separating caustic soda and fresh water from seawater by using green energy in accordance with one embodiment of the present invention, FIGS. 2 to 4 are views of a running water power generation arrangement of the apparatus in accordance with the embodiment of the present invention, and FIG. 5 is a view of an evaporation tower of the apparatus in accordance with the embodiment of the present invention.

As shown in the drawings, the apparatus 100 for separating caustic soda and fresh water from seawater by using green energy includes: a water reservoir 110 pumping, temporarily storing, and discharging a predetermined amount of seawater after primary electrolysis; a watercourse 120 connected to one side of the water reservoir 110 to allow the seawater discharged from the water reservoir 110 to flow there through while secondarily electrolyzing the primarily electrolyzed seawater; positive and negative electrodes 130 respectively provided to opposite sides of the water reservoir 110 and the watercourse 120 to electrolyze the seawater; a power supply 140 disposed at one side of the watercourse 120 to supply electricity to the electrodes 130; a running water power generation arrangement 150 generating and supplying electric power to the power supply 140; and an evaporation tower 160 guiding the caustic soda-containing water, that is, the seawater, electrolyzed through the watercourse 120 into the evaporation tower 160 and evaporating the caustic soda-containing water to separate caustic soda and fresh water from the caustic soda-containing water by spraying and heating the caustic soda-containing water.

Specifically, referring to FIGS. 1 and 2, the water reservoir 110 serves to store and primarily electrolyze a predetermined amount of seawater pumped into the water reservoir 110 from the outside of the apparatus, and has an opening formed at one side of the water reservoir 110 to discharge the primarily electrolyzed seawater to the watercourse 120.

The watercourse 120 is connected at one end thereof with the opening of the water reservoir 110 to allow the seawater to flow there through while secondarily electrolyzing the seawater. The watercourse 120 includes a connection conduit 121 which has a U-shaped cross-section open at one side thereof, and a storage bath 122 which is formed at the other side of the connection conduit and temporarily stores the caustic soda-containing water electrolyzed through the water reservoir 110 and the watercourse 120 to pump the caustic soda-containing water to the evaporation tower 160.

The watercourse 120 may be formed by connecting unit passage members to each other so as to prevent water leakage. Here, each unit passage member is made of concrete, metal or synthetic resin and has a constant length.

For example, the watercourse 120 may be formed by serially connecting a set of 300-500 unit passage members to each other, in which each of the unit passage members is formed to a size of 1×1×2.5 m. Here, the length of the watercourse 120 may be changed by increasing or decreasing the number of unit passage members according to conditions. Further, it should be understood that the watercourse 120 may have various dimensions according to surrounding conditions by changing the length, width or height thereof.

The watercourse 120 is configured to allow the seawater to naturally flow from the water reservoir 110 to the storage bath 122, and may be slanted at an angle of 45 degrees or less depending on the shape of the land on which the apparatus is installed.

The electrodes 130 comprise a plurality of cathodes (−) and anodes (+) arranged at constant intervals along the opposite sides of the water reservoir 110 to primarily electrolyze the seawater stored in the water reservoir 110, and a plurality of cathodes (−) and anodes (+) arranged at constant intervals along the opposite sides of the connection duct 121 to secondarily electrolyze the seawater flowing along the connection duct 121.

The power supply 140 is disposed at one side of the watercourse 120 to accumulate electric power generated by the running water power generation arrangement 150 and supply the accumulated electric power to the electrodes 130 and the evaporation tower 160.

The electric power generation arrangement 150 generates electricity through environmentally friendly power generation, such as solar power generation and running water power generation by using seawater flowing through the watercourse 120, and supplies the electricity to the power supply 140.

As shown in FIGS. 1 to 4, the power generation arrangement 150 includes a solar power generation arrangement 1510, which serves as a primary power generation arrangement and includes a plurality of solar panels installed to allow angle adjustment and collecting sunlight to generate electricity, and a running water power generation arrangement 1520, which serves as a secondary power generation arrangement and generates a rotational force with the seawater flowing along the watercourse 120 so that the rotational force is used to operate a generator therein to generate electricity.

Here, since a direct current is used to electrolyze the seawater using the electrodes 130 of the water reservoir 110 and the watercourse 120, a direct current generated by the solar power generation arrangement 1510 is directly supplied to the power supply 140 and an alternating current generated by the running water power generation arrangement 1520 is converted into a direct current before being supplied to the power supply 140.

Here, although both the solar power generation arrangement 1510 and the running water power generation arrangement 1520 are provided to secure maximum power generation potential in this embodiment, it should be noted that the apparatus may include one of the two generations so long as it can provide sufficient electric power.

Further, the solar power generation arrangement 1510 is composed of a plurality of solar power generators arranged along the upper side of the watercourse 120. Here, the solar power generators may also be disposed on the ground outside the watercourse 120 to secure sufficient power generation potential.

The running water power generation arrangement 1520 is composed of a plurality of running water power generators arranged at constant intervals inside the watercourse 120.

Each of the running water power generators includes a propeller 1522 rotated by the seawater flowing along the watercourse 120, an acceleration gear assembly 1524 including a large-diameter gear and a small-diameter gear engaging with each another to rotate and transmit the rotational force of the propeller 1522, and a generator 1526 generating electric power using the rotational force transmitted from the acceleration gear assembly 1524.

Each of blades constituting the propeller 1522 has a semi-spherical shape concaved in one direction to allow smooth rotation corresponding to the flow of the seawater and is secured to a lower end of a rotational shaft by welding or a bolt and a nut.

Namely, the propeller 1522 has a multi-stage structure and is secured to one end of the rotational shaft 1523 that is rotatably disposed inside a stationary frame 1521 and is separated from the bottom of the watercourse.

The acceleration gear assembly 1524 includes large-diameter gears, one of which is coupled to the rotational shaft 1523, and small-diameter gears alternately engaging with the large-diameter gears to increase a rotational speed by a gear ratio of about 10:1, so that an increased rotational force can be transmitted to the generator 1526 even when the propeller 1522 rotates at a slow speed due to low speed of seawater flowing along the watercourse 120.

Herein, although the gear ratio of the large-diameter gear to the small-diameter gear is illustrated as about 10:1, it should be understood that the invention is not limited thereto.

The evaporation tower 160 receives and heats the caustic soda-containing water, that is, the seawater, which is electrolyzed through the watercourse 120 and stored in the storage bath 122.

Referring to FIGS. 1 and 5, the evaporation tower 160 generates and discharges vapor by raising the caustic soda-containing water from the storage bath 122 of the watercourse 120 to an upper side of the evaporation tower 160 through a pump (not shown), followed by spraying and heating the caustic soda-containing water inside the evaporation tower 160. The evaporation tower 160 includes an ejection port 1601 through which the caustic soda-containing water supplied from the storage bath 122 is ejected into the evaporation tower 160, at least three evaporation chambers 1610 which are sequentially stacked from an upper side within the evaporation tower 160 and heat the caustic soda-containing water ejected through the ejection port 1601 to generate vapor, and a vapor turbine generator 1620 which receives the vapor from the evaporation chambers 1610 through a flow duct 1615 to generate electric power.

Here, the interior of the evaporation tower 160 is divided into at least three spaces to sequentially stack the at least three evaporation chambers 1610. Each of the spaces receiving the corresponding evaporation chamber 1610 therein is formed at the ceiling thereof with a spray port 1602, through which the caustic soda-containing water passed through the evaporation chamber 1610 is sprayed downward, and is provided at the front side thereof with a door 1604 capable of being opened or closed to maintain and check the evaporation chamber 1610.

In this embodiment, the evaporation tower 160 is configured to allow the caustic soda-containing water to be sprayed downward to the lower end of the evaporation tower 160 using the force of gravity, but the present invention is not limited thereto. Alternatively, the evaporation tower 160 may include rotating motors inside the ejection port 1601 and the spray port 1602 to spray the caustic soda-containing water.

Further, as shown in FIG. 5, the evaporation chambers 1610 are sequentially stacked inside the evaporation tower 160 and heat the caustic soda-containing water ejected and sprayed through the ejection port 1601 and the spray ports 1602 thereof.

Specifically, each of the evaporation chambers 1610 includes a heater 1612 secured therein to heat the sprayed caustic soda-containing water, an ultrasonic wave generator 1614 mounted at one side of the evaporation chamber 1610 to generate ultrasonic waves when a side section of the evaporation chamber 1610 is filled with the heated caustic soda-containing water, and a magnetron 1616 mounted at the other side of the evaporation chamber 1610 to explosively increase the kinetic energy of vapor by momentarily heating vapor particles evaporated by the heater 1612 and the ultrasonic wave generator 1614.

At this time, the vapor evaporated from the caustic soda-containing water by the heater 1612 and the magnetron 1614 is decomposed into fine particles by microwaves generated from the magnetron 1616 and is finally discharged through the flow duct 1615 to operate the vapor turbine generator 1620. Then, the vapor turbine generator 1620 generates and supplies electricity to the heater 1612, ultrasonic wave generator 1614 and magnetron 1616 for operation thereof.

The apparatus further includes a fresh water storage tank 1625 which is located outside the evaporation tower 160 and collects the water of vapor cooled after operating the vapor turbine generator 1620 to use fresh water obtained from the cooled vapor as water for agriculture and other industries, and a caustic soda storage tank 1630 which is located outside the evaporation tower 160 and collects concentrated caustic soda heated by the three evaporation chambers 1610 and discharged through a discharge port 1603. Here, the concentrated caustic soda, for instance, may be mixed with sawdust to thereby produce a natural organic fertilizer.

Next, a method of separating caustic soda and fresh water from seawater by using green energy in accordance with one embodiment of the invention will be described with reference to FIGS. 1 to 5, 6 and 7.

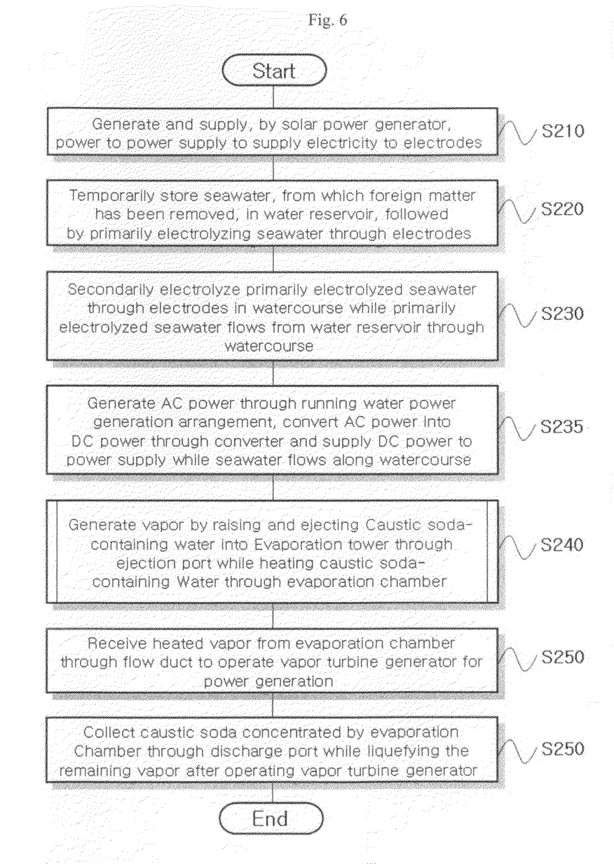

FIG. 6 is a flowchart of a method of separating caustic soda and fresh water from seawater by using green energy in accordance with one embodiment of the invention, and

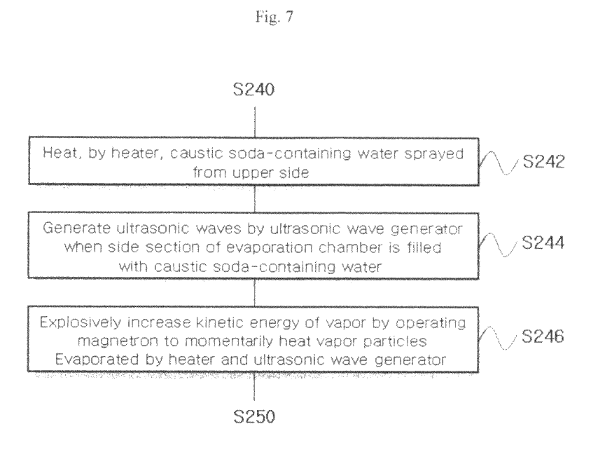

FIG. 7 is a flowchart of a subroutine of operation S240 in the method of FIG. 6.

First, electric power is generated from the solar power generation arrangement 1510 and supplied to the power supply 140 which in turn supplies electricity to the electrodes 130 in S210, and the pumps to draw up seawater.

Then, seawater from which foreign matter has been removed is temporarily stored in the water reservoir 110 and subjected to primary electrolysis through the electrodes 130 in S220.

Next, the primarily electrolyzed seawater is subjected to secondary electrolysis through the electrode 130 in the watercourse 120 while flowing along the watercourse 120 in

S230.

Here, while the seawater flows along the watercourse 120, an alternating current is generated by the running water power generation arrangement 1520, converted into a direct current by the converter 1525, and is then supplied to the power supply 140 in S235.

Then, the caustic soda-containing water, that is, the seawater subjected to the secondary electrolysis in S230, is raised and sprayed into the evaporation tower 160 through the ejection port 1601 while being heated through the evaporation chambers 1610 to generate vapor in S240.

At this time, in S240, the process of generating vapor by heating the caustic soda-containing water through the evaporation chambers 1610 includes heating, by the heater 1612, the caustic soda-containing water sprayed from an upper side of each of the evaporation chambers 1601 in S242, generating ultrasonic waves by the ultrasonic wave generator 1614 when a side section of the evaporation chamber 1601 is filled with the caustic soda-containing water, in S244, and explosively increasing the kinetic energy of vapor by operating the magnetron 1616 to momentarily heat vapor particles evaporated by the heater 1612 and the ultrasonic wave generator 1614, in S246.

Then, the heated vapor is supplied from the evaporation chambers 1610 to the vapor turbine generator 1620 through the flow duct 1615 to operate the vapor turbine generator 1620 for power generation in S250.

Here, the vapor turbine generator 1620 generates and supplies electricity to the heater 1612, ultrasonic wave generator 1614 and magnetron 1616 for operation thereof.

Next, the caustic soda concentrated through the evaporation chambers 1610 in S240 is collected through the discharge port 1603, and the vapor after operating the vapor turbine generator 1620 in S250 is liquefied to be used as fresh water in S260.

Thus, as described above, according to the embodiment, the method can separate caustic soda and fresh water from seawater by generating electricity through the solar power generation arrangement, the running water power generation arrangement and the vapor turbine power generator without the use of an external power supply.

Although some embodiments have been provided to illustrate the invention in conjunction with the drawings, it will be apparent to those skilled in the art that the embodiments are given by way of illustration only, and that that various modifications, changes, and alterations can be made without departing from the spirit and scope of the invention. The scope of the invention should be limited only by the accompanying claims.

What is claimed is:

1. An apparatus for separating caustic soda and fresh water from seawater by using green energy such as sunlight or running water power, comprising:
a water reservoir pumping, purifying and discharging a predetermined amount of seawater;
a watercourse connected to one side of the water reservoir to allow the seawater discharged from the water reservoir to flow there through;
positive and negative electrodes respectively provided to opposite sides of the water reservoir and the watercourse to electrolyze the seawater;
a power supply disposed at one side of the watercourse to supply electricity to the electrodes;
a power generation arrangement generating and supplying electric power to the power supply; and
an evaporation tower guiding the caustic soda-containing water electrolyzed through the watercourse into the evaporation tower and evaporating the water to separate caustic soda and fresh water from the water by spraying and heating the water.

2. The apparatus of claim 1, wherein the watercourse comprises a connection conduit having a U-shaped cross-section open at one side thereof, and a storage bath formed at the other side of the connection conduit and temporarily storing the water electrolyzed through the water reservoir and the watercourse to supply the water to the evaporation tower.

3. The apparatus of claim 1, wherein the power generation arrangement comprises a solar generation arrangement comprising a plurality of solar panels installed to allow angle adjustment and collecting sunlight to generate electricity.

4. The apparatus of claim 1, wherein the power generation arrangement comprises a running water power generation arrangement that generates a rotational force using the seawater flowing along the watercourse and uses the rotational force to generate electricity.

5. The apparatus of claim 4, wherein the running water power generation arrangement comprises a plurality of generators arranged at constant intervals inside the watercourse, and each of the generators comprises a propeller rotated by the seawater flowing along the watercourse, an acceleration gear assembly comprising a large-diameter gear and a small-diameter gear engaging with each other to rotate and transmit the rotational force of the propeller, and a generator generating electric power using the rotational force transmitted from the acceleration gear assembly.

6. The apparatus of claim 1, wherein the evaporation tower comprises an ejection port through which the water supplied from the storage bath of the watercourse is ejected into the evaporation tower, at least three evaporation chambers sequentially stacked from an upper side within the evaporation tower and heating the water ejected through the ejection port to generate vapor, and a vapor turbine generator receiving the vapor from the evaporation chambers through a flow duct to generate electric power.

7. The apparatus of claim 6, wherein the evaporation tower has an interior divided into at least three spaces that receive the at least three evaporation chambers sequentially stacked therein, respectively, and each of the spaces is formed at a bottom thereof with a spray port, through which the water passed through the evaporation chamber is sprayed downward, and is provided at a front side thereof with a door capable of being opened or closed to maintain and check the evaporation chamber.

8. The apparatus of claim 6, wherein the evaporation chamber comprises a heater secured therein to heat the ejected and sprayed water through the ejection port and the spray port, an ultrasonic wave generator mounted at one side of the evaporation chamber to generate ultrasonic waves when a side section of the evaporation chamber is filled with the water, and a magnetron mounted at the other side of the evaporation chamber to explosively increase kinetic energy of vapor by momentarily heating vapor particles evaporated by the heater and the ultrasonic wave generator.

9. The apparatus of claim 6, further comprising:
a fresh water storage tank located outside the evaporation tower and collecting the vapor after operating the vapor turbine generator to use fresh water obtained from the cooled vapor as water for agriculture and other industries; and
a caustic soda storage tank located outside the evaporation tower and collecting concentrated caustic soda by the evaporation chambers and discharged through a discharge port.

10. A method of separating caustic soda and fresh water from seawater by using green energy such as solar or running water power, comprising:
generating and supplying, by a solar power generation arrangement, electric power to power supply to supply electricity to electrodes;
temporarily storing seawater, from which foreign matter has been removed, in a water reservoir, followed by primarily electrolyzing the seawater through the electrodes;
secondarily electrolyzing the primarily electrolyzed seawater through the electrodes in a watercourse while allowing the primarily electrolyzed seawater to flow from the water reservoir through the watercourse;
generating vapor by raising and ejecting the electrolyzed caustic soda-containing water into an evaporation tower through an ejection port while heating the caustic soda-containing water through an evaporation chamber;
receiving the heated vapor from the evaporation chamber through a flow duct to operate a vapor turbine generator for power generation; and
collecting caustic soda concentrated in the evaporation chamber through a discharge port while liquefying the remaining vapor to use as fresh water after operating the vapor turbine generator.

11. The method of claim 10, wherein, while the seawater flows along the watercourse, an alternating current is generated by a running water power generation arrangement, converted into a direct current by a converter and then supplied to the power supply.

12. The method of claim 10, wherein generating vapor by heating the water through the evaporation chamber comprises:
heating, by a heater, the water sprayed from an upper side of the evaporation chamber;
generating, by an ultrasonic wave generator, ultrasonic waves when a side section of the evaporation chamber is filled with the water; and
explosively increasing kinetic energy of vapor by operating a magnetron to momentarily heat vapor particles evaporated by the heater and the ultrasonic wave generator.

13. The method of claim 12, wherein the heater, the ultrasonic wave generator and the magnetron are operated by electricity generated by a vapor turbine power generator disposed outside the evaporation tower.
